(19) United States
(12) Patent Application Publication
(10) Pub. No.: US 2006/0186577 A1
(43) Pub. Date: Aug. 24, 2006

(54) Method of manufacturing cylindrical encoder

(76) Inventors: Yasuo Taniguchi, Okayama (JP); Kenji Nakagawa, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/407,268

(22) Filed: Apr. 20, 2006

Related U.S. Application Data
(63) Continuation of application No. 10/408,552, filed on Apr. 8, 2003.

(30) Foreign Application Priority Data
Apr. 8, 2003 (JP) 2002-104806

(51) Int. Cl. B28B 3/02; B29B 13/00

(52) U.S. Cl. 264/319; 264/271.1; 264/427; 264/139

(57) ABSTRACT

The invention provides a method of manufacturing a cylindrical encoder, molded from rubber material, containing ferromagnetic powders mixed therein, using a pair of metal molds comprising an upper metal mold and a lower metal mold. The lower metal mold has a cylindrical cavity which is provided with a pot portion at an inlet side thereof, a rectification receiving portion at an outlet side thereof opposing to the inlet side, and a rectification portion between the pot portion and the rectification receiving portion at the inside of the pot portion. An annular shaped rubber material using the rubber material is formed, and mounted on the pot portion of the lower metal mold. The annular shaped rubber material is compressed on to the lower metal mold by using the upper metal mold with the applied heating, thereby charged into the cylindrical cavity.

This application is a continuation of U.S. application Ser. No. 10/408,552, filed Apr. 8, 2003.

### BACKGROUND OF THE INVENTION

1. Field of the Invention

The present invention relates to a method of manufacturing a cylindrical encoder used as a component of rotation speed detecting apparatus provided for detecting a speed of rotation for wheels or the like on an automobile vehicle or the like. Particularly, the present invention relates to a method of manufacturing a cylindrical encoder, made of magnet rubber, having a strong magnetic force when it is magnetized and variation and/or irregularity of magnetism in the circumferential direction of it is slight.

2. Description of the Related Art

The automobile vehicle is installed with a safety driving mechanism such as an antilock braking system, a traction control system, a stability control system and the like. An encoder generating a pulse for detecting the number of revolutions for the wheels or the like on the automobile vehicle or the like is installed in order to improve a flexibility of control on the safety driving mechanism. The encoder mentioned above is arranged in a hub flange or the like in a suspension apparatus on the automobile vehicle, and is used for detecting the number of revolutions for the wheels. As mentioned above, a difference (displacement) in the number of revolutions between a plurality of wheels such as front, rear, right and left on the automobile vehicle is detected, and a drive apparatus, a brake apparatus or the like is turned on and off. Thereby, an emergency motion of the automobile vehicle is controlled, and a drive safety is ensured.

A lot of methods of manufacturing such encoders have been conventionally proposed.

For example, as a first method, there has been known a method of manufacturing the encoder by forming an annular rubber material, which is formed in an annular shape by bending and connecting an unvulcanized thread rubber material containing magnetic powders or by punching a plate-like rubber material containing magnetic powders in an annular shape. Then, spplying said annular rubber material into a forming die. Compression molding the said annular rubber material by the forming die. Finally, the molded product is magnetized to carry the alternating N and S (or S and N) polarities along the circumferential direction of the circumferential surface of the said molded product.

As a second method, there has been known a method of manufacturing the encoder by directly charging the unvulcanized rubber material, containing magnetic powders, into the molding die from a center portion, and forming under the applied heating. Finally, the molded product is magnetized to carry the alternating N and S (or S and N) polarities along the circumferential direction of the circumferential surface of the said molded product. The second method employs an injection molding method in order to improve operability and a formability.

As a third method, there has been known a method of manufacturing the encoder by causing an electric current to flow to a coil so as to form a magnetic field, molding by the forming die arranged in the formed magnetic field. Thereby, forming a molded product in which magnetic powders in the rubber material are aligned in one direction. Finally, the molded product is magnetized to carry the alternating N and S (or S and N) polarities along the circumferential direction of the circumferential surface of the said molded product.

A cylindrical encoder is inserted into a peripheral surface of a rotating member under the applied pressure, and supported by the said rotating member. And it is used for detecting the speed of rotation for the wheels or the like on the automobile vehicle. An example of general aspect thereof is shown in FIG. 4.

In the case of manufacturing the cylindrical encoder by the conventionally proposed manufacturing methods mentioned above, there have been the following problems.

In the case of manufacturing the cylindrical encoder by the first manufacturing method mentioned above, there appears a defect that the rubber material, which contains the magnetic powders having an anisotropy, is molded with a random direction of the said magnetic powders. So that, in the manufactured cylindrical encoder, the dispersion in a magnetic force is generated, and magnetic force characteristics are not uniform in the circumferential direction.

In the case of manufacturing the cylindrical encoder by the second manufacturing method mentioned above, a satisfactory encoder can be obtained only by using the rubber material which can be injected and charged by making a rubber viscosity low. However, when a lot of magnetic powders are mixed in order to obtain a strong magnetism, the viscosity can not help becoming high. When the viscosity is high, an injection operability is extremely deteriorated. This has been a reason of obstruction on putting the second manufacturing method mentioned above to practical use.

In the case of manufacturing the cylindrical encoder by the third manufacturing method mentioned above, it is unavoidable that a combination structure between the magnetic field generating apparatus and the forming die is large-scaled and complex. Further, in the molding operation using them, the operability is deteriorated very much, and it is unavoidable that a manufacturing cost rises.

### SUMMARY OF THE INVENTION

An object of the present invention is to provide a method capable of solving the problem existing in the conventional methods of manufacturing the cylindrical encoder mentioned above. Another object of the present invention is to provide a method by which a cylindrical encoder can be manufactured efficiently and with good operability. And,according to the said provided method, a cylindrical encoder, having a strong magnetic force when it is magnetized and variation and/or irregularity of magnetism in the circumferential direction of it is slight, can be manufactured.

That is, an object of the present invention is to provide a manufacturing method for manufacturing a cylindrical encoder efficiently and with good operability. And,according to the said provided method, a cylindrical encoder,which has an accurate magnetic pole portion and capable for accurately detecting number of revolutions, can be manufactured.

In order to acieve the object mentioned above, the present invention provides the following method of manufacturing the cylindrical encoder.

In this mthod, a cylindrical encoder, molded from rubber material, containing ferromagnetic powdewrs mixed therein, is manufactured by using a pair of metal molds comprising an upper metal mold and a lower metal mold. The lower metal mold has a cylindrical cavity which is provided with a pot portion at an inlet side thereof, a rectification receiving portion at an outlet side thereof opposing to the inlet side, and a rectification portion between the pot portion and the rectification receiving portion at the inside of the pot portion.

Firstly, an annular shaped rubber material is formed by using said rubber material, containing ferromagnetic powdewrs mixed therein.

Then, said annular shaped rubber material is mounted on the pot portion of the cylindrical cavity provided in the lower metal mold.

The annular shaped rubber material is compressed on to the lower metal mold by using the upper metal mold with the applied heating, thereby the annular shaped rubber material is charged into the cylindrical cavity, and a cylindrical product corresponding to the cylindrical cavity, having a molding portion corresponding to the rectification receiving portion formed on one end side and the other molding portion corresponding to the rectification portion formed on the other end side, is molded.

Then, the molding portions formed on the one end side and the other end side of the molded cylindrical product are cut off.

Finally, the molded cylindrical product, after the said molding portions are cut off, is magnetized to carry the alternating N and S (or S and N) polarities along the circumferential direction of the circumferential surface of the said molded cylindrical product.

In the method of manufacturing the cylindrical encoder in accordance with the present invention, when the annular shaped rubber material, mounted on the pot portion of the cylindrical cavity, is compressed under the applied heating by the upper metal mold and the lower metal mold, the rubber material flows from the rectification portion of the cylindrical cavity to the rectification receiving portion existing at the outlet side of the cylindrical cavity through cylindrical portion existing at a middle of the cylindrical cavity, so it is charged into the cylindrical cavity. Accordingly, at the cylindrical portion existing at a middle of the cylindrical cavity, a directionality of the ferromagnetic powders mixed in the rubber material is aligned in a flow direction, that is, an axial direction of the cylindrical cavity.

In the method of the present invention, as the before described, after the cylindrical product, in which the molding portions corresponding to the rectification receiving portion and the rectification portion are formed in the respective end sides, is molded, the molding portions, formed in the end sides of this molded cylindrical product, are cut off. So that, in the molded cylindrical product, after being cut off as the before described, a complete directionality of the ferromagnetic powders aligned in the axial direction of the said molded cylindrical product is achieved.

An precise magnetized polarities is formed by magnetizing the molded cylindrical product, which has a complete directionality of the ferromagnetic powders aligned in the axial direction of it, to carry the alternating N and S (or S and N) polarities along the circumferential direction. Thereby, the cylindrical encoder which can detect the number of revolutions with a higher precision can be manufactured.

This cylindrical encoder can be manufactured through the following steps.

Compression Molding Step:

Compressing the annular shaped rubber material, mounted on the pot portion of the cylindrical cavity, under the applied heating by the upper metal mold and the lower metal mold.

Cutting Off Step:

Cutting off the molding portions formed on the end sides of the molded cylindrical product, which corresponds to the cylindrical portion existing at a middle of the cylindrical cavity, and correspond to the rectification receiving portion and the rectification portion of the cylindrical cavity respectively.

Magnetizing Step:

Magnetizing the molded cylindrical product, after the molding portions are cut off, to carry the alternating N and S (or S and N) polarities along the circumferential direction of the circumferential surface of the said molded cylindrical product.

Therefore, according to the method of the present invention for manufacturing cylindrical encoder, an operability becomes extremely good.

In the before described method of manufacturing the cylindrical encoder in accordance with the present invention, it can be modified to previously insert a metal ring to the cylindrical cavity of the lower metal mold before mounting the annular shaped rubber material on the pot portion of the cylindrical cavity. In this case,a cylindrical encoder comprises a metal ring and a molded cylindrical product, arrenged at the inner side or outer side of the metal ring, is manufactured.

In the before described method of manufacturing the cylindrical encoder in accordance with the present invention, the annular shaped rubber material may be formed by forming a thread rubber material using the rubber material, containing ferromagnetic powdewrs mixed therein, and then connecting the thread rubber material in an approximately ring shape.

In this case, the annular shaped rubber material can be formed by cutting and bonding the thread rubber material, which is extrusion molded by an extrusion molding machine using the rubber material containing ferromagnetic powdewrs mixed therein.

Alternatively, in this case, the annular shaped rubber material can be formed by forming a plate-like rubber material using the rubber material, containing ferromagnetic powdewrs mixed therein, and then cutting out the plate-like rubber material, and thereafter bonding the cut off plate-like rubber material so as to connect in a ring shape.

Also, in the before described method of manufacturing the cylindrical encoder in accordance with the present invention, the annular shaped rubber material may be formed by forming a plate-like rubber material using the rubber material, containing ferromagnetic powdewrs mixed therein, and then directly stamping the plate-like rubber material in a ring shape to form the annular shaped rubber material.

Further, in the before described method of manufacturing a cylindrical encoder, it can be modified that the circumferential surface of the molded cylindrical product on which magnetization magnetizing to carry the alternating N and S (or S and N) polarities along the circumferential direction is to be condunted is ground, when the molding portions formed on the end sides of the molded cylindrical product are cut off.

The surface of the molded cylindrical product, on which the alternating N and S (or S and N) polarities along the circumferential direction is carried, forms a revolution number detecting surface. A smooth surface can be formed by applying a grinding process of this surface at the same time of the cut-off step mentioned above. As the revolution number detecting surface is formed in the smooth surface in the manner mentioned above, it is possible to accurately set a gap between the revolution number detecting surface and a sensor which is arranged so as to oppose to the revolution number detecting surface and detects a pulse generated from the revolution number detecting surface. Thereby, it is possible to achieve a more accurate rotation speed detection.

As the before described, in accordance with the method of manufacturing the cylindrical encoder of the present invention, since it is possible to carry out the step of forming the revolution number detecting surface in the smooth surface at the same time of the cut-off step mentioned above, an operability becomes good.

As described above, in accordance with the method of manufacturing the cylindrical encoder of the present invention, the molded cylindrical product, obtained by compressing annular shaped rubber material by the upper metal mold and lower metal mold under applied heating, and after the molding portions corresponding to the rectification receiving portion and the rectification portion formed in the end sides of it are cut off, has a complete directionality and uniform density of the ferromagnetic powders aligned in the axial direction of the said molded cylindrical product. Thereby, an precise magnetized polarities can be formed by magnetizing the molded cylindrical product, which has a complete directionality of the ferromagnetic powders aligned in the axial direction of it, to carry the alternating N and S (or S and N) polarities along the circumferential direction. So that, the cylindrical encoder which can detect the number of revolutions with a higher precision can be manufactured.

In accordance with the method of manufacturing the cylindrical encoder of the present invention, a good molding workability and an improved operability can be achieved. In particular, in a finishing workability, an excellent advantage can be achieved.

Further, in accordance with the cylindrical encoder manufactured by the method of manufacturing the cylindrical encoder of the present invention, since it is possible to secure a wide magnetic pole space, and an accurate magnetization is carried out, it is possible to detect the number of revolutions with a higher precision

### BRIEF DESCRIPTION OF THE DRAWINGS

FIG. 1 is a cross sectional view describing a molding step in a manufacturing method in accordance with the present invention;

FIG. 2 is a cross sectional view of a molded cylindrical product formed by the molding step illustrated in FIG. 1 in a partly omitted manner;

FIG. 3 is a cross sectional view describing a cut-off step in the manufacturing method in accordance with the present invention;

FIG. 4 is a perspective view showing one example of a cylindrical encoder manufactured by the manufacturing method in accordance with the present invention; and

FIG. 5 is a cross sectional view describing another cut-off step in the manufacturing method in accordance with the present invention.

### DESCRIPTION OF THE PREFERRED EMBODIMENT

A description will be given below of a preferable embodiment in accordance with the present invention with reference to the accompanying drawings.

An unvulcanized rubber for forming an annular shaped rubber material can be prepared by a method known in a technical field of manufacturing an encoder made of a magnetic rubber.

For example, an unvulcanized rubber is made by blending ferromagnetic powders of about 70 to 98% weight ratio in a polymer such as NBR, H-NBR (hydrogenation NBR) or the like, and mixing rubber chemicals together therewith. In this case, a ferrite powder which is inexpensive and can hold a ferromagnetism is best as the ferromagnetic powders, and is recommendable since it is easily handled in view of a milling operability and an extruding operability.

Next, an annular shaped rubber material 1 is prepared, for example, by extruding the unvulcanized rubber, prepared in the manner mentioned above, into a thread shape by using an extruding machine. And then cutting the extruded thread shape rubber material, and bonding to form annular rubber material 1.

In the manufacturing method of the present invention, a lower metal mold 2b and an upper metal mold 2a illustrated in FIG. 1 are used.

The lower metal mold 2b is provided with a cylindrical cavity 21b as illustrated in FIG. 1. The cylindrical cavity 21b has a pot portion 22 at an inlet side thereof, a rectification receiving portion 32 at an outlet side thereof opposing to the inlet side, and a rectification portion 31 between the pot portion 22 and the rectification receiving portion 32 at the inside of the pot portion 22 as illustrated in FIG. 1.

In the manufacturing aspect illustrated in FIG. 1, a metal ring 4 is first inserted to the cylindrical cavity 21b of the lower metal mold 2b.

Next, the annular shaped rubber material 1 prepared in the manner mentioned above is mounted on the pot portion 22 of the lower metal mold 2b as illustrated in FIG. 1.

Then, compressing the annular shaped rubber material 1 on to the lower metal mold 2b by using the upper metal mold 2a with the applied heating, thereby charging the annular shaped rubber material 1 into the cylindrical cavity 21b.

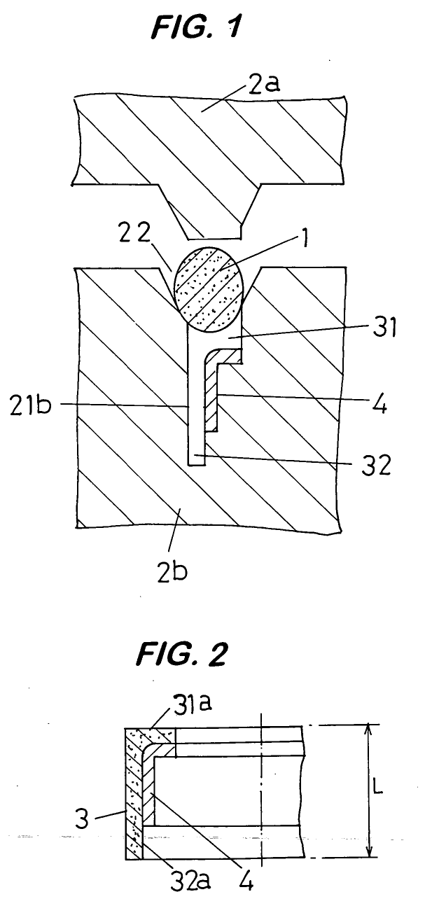

Thereby, as illustrated in FIG. 2, a molded cylindrical product 3 corresponding to the cylindrical cavity 21b and having a molding portion 32a, corresponding to the rectification receiving portion 32 formed on one end side, and a molding portion 31a, corresponding to the rectification portion 31 formed on the other end side, is molded.

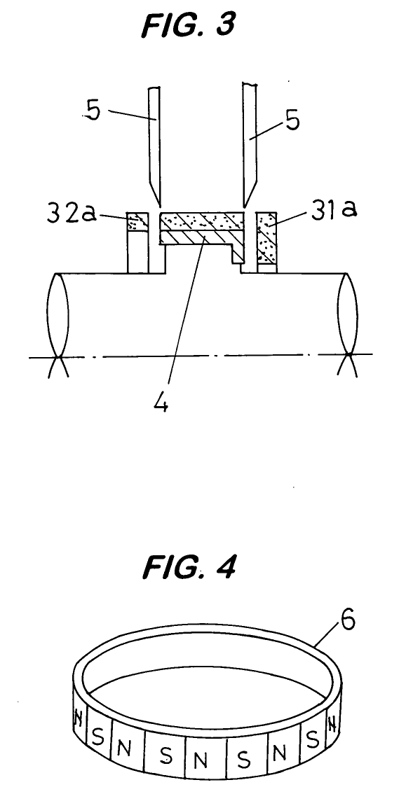

Then, as illustrated in FIG. 3, the molding portions 31a and 32a formed on the end sides of the molded cylindrical product 3 are cut off by using a cutting device 5 such as a knife and a cutter.

Finally, the molded cylindrical product 3, after the molding portions 31a and 32a are cut off, is magnetized to carry the alternating N and S (or S and N) polarities along the circumferential direction of the circumferential surface of it.

Thereby, a cylindrical encoder 6 illustrated in FIG. 4 is obtained.

In this case, at a time of cutting off the molding portions 31a and 32a, it is possible to use a lathe cutting tool, a grinding blade or the like.

Further, as illustrated in FIG. 3, it is possible to grind an outer peripheral surface of the cylindrical product 3, which forms a revolution number detecting surface, at the same time of cutting off the molding portions 31a and 32a.

In the embodiment mentioned above, the metal ring 4 is first inserted to the cylindrical cavity 21b of the lower metal mold 2b, and in the manufactured cylindrical encoder, the metal ring 4 is arranged in the inner peripheral side, and the magnet rubber is arranged in the outer peripheral side.

However, it is possible to manufacture a cylindrical encoder 6 manufactured only by a magnet rubber as illustrated in FIG. 4, without inserting the metal ring 4 to the cylindrical cavity 21b of the lower metal mold 2b.

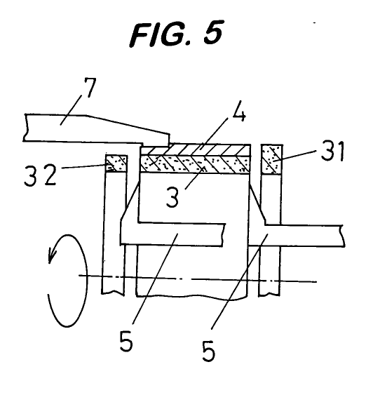

Further, as illustrated in FIG. 5, it is possible to form a cylindrical encoder in which the metal ring 4 is arranged in the outer peripheral side, and the magnet rubber is arranged in the inner peripheral side, as illustrated in FIG. 5, by inserting the metal ring 4 firstly to the cylindrical cavity 21b of the lower metal mold 2b. In the cylindrical magnet manufactured as illustrated in FIG. 5, the inner peripheral surface side forms the revolution number detecting surface.

In this case, in the embodiment illustrated in FIG. 5, the molding portions 31a and 32a are cut off by clamping the metal ring 4 in the outer peripheral side by a chuck 7 and applying the cutting tool 5 from the inner peripheral side.

In the aspect illustrated in FIG. 5, it is possible to grind the inner peripheral surface of the cylindrical product 3, forming the revolution number detecting surface, at the same time of cutting off the molding portions 31a and 32a.

In the manufacturing method of the cylindrical encoder in accordance with this invention, it is preferable that a length (a length in a vertical direction in FIG. 3) L of the molded cylindrical product including the molding portions 31a and 32a as shown by reference numeral 3 in FIG. 2 has an extra size about 5 to 50% with respect to a cylinder size in a vertical direction of the cylindrical encoder 6 illustrated in FIG. 4. If the length L of the molded cylindrical product 3 becomes larger than the above size, it is not preferable due to an increase of a material cost. On the other hand, if the length L of the molded cylindrical product 3 is smaller than the above size, it is not preferable due to a problem left in the alignment in the directionality of the ferromagnetic powders in the axial direction of the cylindrical product 3.

Accordingly, it is necessary to set a depth of the cylindrical cavity 21b of the lower metal mold 2b to a size obtained by taking the length L of the molded cylindrical product 3 into consideration.

Although the present invention has been described with reference to the particular preferred embodiments thereof, it should be understood that various changes and modifications might be made without departing from the spirit and scope of the invention as defined in the appended claims.

What is claimed is:

1. A method of manufacturing a cylindrical encoder, molded from rubber material, containing ferromagnetic powdewrs mixed therein, using a pair of metal molds comprising an upper metal mold and a lower metal mold wherein said lower metal mold has a cylindrical cavity which is provided with a pot portion at an inlet side thereof, a rectification receiving portion at an outlet side thereof opposing to the inlet side, and a rectification portion between the pot portion and the rectification receiving portion at the inside of the pot portion, the method comprising:
forming an annular shaped rubber material using said rubber material;
mounting said annular shaped rubber material on the pot portion of the lower metal mold;
compressing the annular shaped rubber material on to the lower metal mold by using the upper metal mold with the applied heating, thereby charging the annular shaped rubber material into the cylindrical cavity, and molding a cylindrical product corresponding to the cylindrical cavity having a molding portion corresponding to the rectification receiving portion formed on one end side and the other molding portion corresponding to the rectification portion formed on the other end side;
cutting off the molding portions formed on the one end side and the other end side of the molded cylindrical product; and
magnetizing the molded cylindrical product, after the said molding portions are cut off, to carry the alternating N and S (or S and N) polarities along the circumferential direction of the circumferential surface of the said molded cylindrical product.

2. A method of manufacturing a cylindrical encoder, molded from rubber material, containing ferromagnetic powdewrs mixed therein, using a pair of metal molds comprising an upper metal mold and a lower metal mold wherein said lower metal mold has a cylindrical cavity which is provided with a pot portion at an inlet side thereof, a rectification receiving portion at an outlet side thereof opposing to the inlet side, and a rectification portion between the pot portion and the rectification receiving portion at the inside of the pot portion, the method comprising:
forming an annular shaped rubber material using said rubber material;
inserting a metal ring into a cylindrical cavity of a lower metal mold;
mounting said annular shaped rubber material on the pot portion of the lower metal mold;
compressing the annular shaped rubber material on to the lower metal mold by using the upper metal mold with the applied heating, thereby charging the annular shaped rubber material into the cylindrical cavity, and molding a cylindrical product corresponding to the cylindrical cavity having a molding portion corresponding to the rectification receiving portion formed on one end side and the other molding portion corresponding to the rectification portion formed on the other end side;
cutting off the molding portions formed on the one end side and the other end side of the molded cylindrical product; and
magnetizing the molded cylindrical product, after the said molding portions are cut off, to carry the alternating N and S (or S and N) polarities along the circumferential direction of the circumferential surface of the said molded cylindrical product on which the metal ring is not arranged.

3. A method of manufacturing a cylindrical encoder according to claim 1, wherein the annular shaped rubber material is formed by forming a thread rubber material using the rubber material, containing ferromagnetic powders mixed therein, and then connecting the thread rubber material in an approximately ring shape.

4. A method of manufacturing a cylindrical encoder according to claim 1, wherein the annular shaped rubber material is formed by forming a plate-like rubber material using the rubber material, containing ferromagnetic powders mixed therein, and then stamping the plate-like rubber material in a ring shape.

5. A method of manufacturing a cylindrical encoder according to claim 1, wherein the circumferential surface of the molded cylindrical product on which magnetization magnetizing to carry the alternating N and S (or S and N) polarities along the circumferential direction is to be conducted is ground, when the molding portions formed on the one end side and the other end side of the molded cylindrical product are cut off.

6. A method of manufacturing a cylindrical encoder according to claim 2, wherein the annular shaped rubber material is formed by forming a thread rubber material using the rubber material, containing ferromagnetic powders mixed therein, and then connecting the thread rubber material in an approximately ring shape.

7. A method of manufacturing a cylindrical encoder according to claim 2, wherein the annular shaped rubber material is formed by forming a plate-like rubber material using the rubber material, containing ferromagnetic powders mixed therein, and then stamping the plate-like rubber material in a ring shape.

8. A method of manufacturing a cylindrical encoder according to claim 2, wherein the circumferential surface of the molded cylindrical product on which magnetization magnetizing to carry the alternating N and S (or S and N) polarities along the circumferential direction is to be conducted is ground, when the molding portions formed on the one end side and the other end side of the molded cylindrical product are cut off.

9. A method of manufacturing a cylindrical encoder according to claim 3, wherein the circumferential surface of the molded cylindrical product on which magnetization magnetizing to carry the alternating N and S (or S and N) polarities along the circumferential direction is to be conducted is ground, when the molding portions formed on the one end side and the other end side of the molded cylindrical product are cut off.

10. A method of manufacturing a cylindrical encoder according to claim 4, wherein the circumferential surface of the molded cylindrical product on which magnetization magnetizing to carry the alternating N and S (or S and N) polarities along the circumferential direction is to be conducted is ground, when the molding portions formed on the one end side and the other end side of the molded cylindrical product are cut off.
